(19) United States
(12) Patent Application Publication
(10) Pub. No.: US 2025/0388130 A1
(43) Pub. Date: Dec. 25, 2025

(54) Method for Controlling a Vehicle by Altitude Prediction Based on Identification of High-Energy Area and Vehicle Using the Same

(71) Applicants: Hyundai Motor Company, Seoul (KR); Kia Corporation, Seoul (KR)

(72) Inventors: Young Kwang Kim, Hwaseong-Si (KR); Byung Woo Jeon, Hwaseong-Si (KR)

(21) Appl. No.: 18/932,806

(22) Filed: Oct. 31, 2024

(30) Foreign Application Priority Data
Jun. 25, 2024 (KR) 10-2024-0082815

(51) Int. Cl. B60L 58/40; B60L 7/10; B60L 50/75; B60L 58/13; G01C 21/00; G01C 21/12

(52) U.S. Cl. CPC B60L 58/40; B60L 7/10; B60L 50/75; B60L 58/13; G01C 21/005; G01C 21/12; B60L 2240/12; B60L 2240/423

(57) ABSTRACT

A method for controlling a vehicle by using altitude prediction based on high-energy area information may comprise: generating a predicted altitude based on a location and a driving direction of the vehicle; in response to driving of the vehicle in a high-energy area identified in map information, setting a highest altitude of the high-energy area as a highest predicted altitude; generating adjusted power based on the predicted altitude, the highest predicted altitude and a current altitude of the vehicle; and based on static power required based on the location and the adjusted power that are to be supplied to a battery of the vehicle, generating a target power generation amount to be supplied to the battery and controlling the vehicle based on the target power generation amount.

### CROSS REFERENCE TO RELATED APPLICATIONS

The present application claims priority to a Korean provisional application No. 10-2024-0082815, filed Jun. 25, 2024, the entire contents of which are incorporated herein for all purposes.

### TECHNICAL FIELD

The present disclosure relates to a vehicle control method by altitude prediction based on identification of a high-energy area and a vehicle, and more particularly, to a vehicle control method that implements driving power control by controlling predictive power generation for a battery through preemptive identification of a high-energy area on a route and a vehicle using the method.

### BACKGROUND

Front altitude prediction is integral to driving power control and accurate distance to empty (DTE) calculation of a vehicle (e.g., an electrified vehicle that is driven based on electric energy). An electrified vehicle may charge a battery by using the battery as a buffer and absorbing gravitational potential energy through regenerative braking in a downhill section or increase potential energy by operating a driving motor in an uphill section and using energy stored in the battery. A vehicle, which charges a battery according to power generation of a fuel cell, may charge the battery with power necessary for uphill driving by power generation of the fuel cell according to a condition of an uphill section.

In a high-energy area, like a high-gradient section, there may be a large exchange between energy accumulated in a battery and potential energy. This large exchange may necessitate predicting a DTE and performing predictive control of a fuel cell. If there is no control of fuel cell prediction, driving on a heavyweight and high-gradient section may be abnormal due to constant discharge from a battery state of charge, and forced charging of a high-voltage battery may be required after stop. In the case of a fuel cell-based vehicle, if the front gradient is not considered in predicting a DTE, a battery may be discharged earlier than expected in an uphill section, which may result in an undrivable situation. That is, in the case of an electrified vehicle, front altitude prediction is further necessary for power generation control prediction of a fuel cell, output control of a high-voltage battery, and DTE prediction.

If a route to a destination is set by a navigation system, predictive control of a fuel cell may be restrictively performed by using gradient information of a front road within a predetermined distance. If no route is set by the navigation system, front altitude prediction according to the navigation system and predictive control of the fuel cell using the prediction cannot be implemented.

### SUMMARY

The following summary presents a simplified summary of certain features. The summary is not an extensive overview and is not intended to identify key or critical elements.

Systems, apparatuses, and methods are described for a method for controlling a vehicle by altitude prediction based on identification of high-energy area and vehicle using the same. A method performed by a vehicle may comprise generating, based on a location of the vehicle, a predicted altitude of the vehicle; setting, based on map information indicating the vehicle is driving in a high-energy area, a highest altitude of the high-energy area as a highest predicted altitude; generating, based on the predicted altitude, the highest predicted altitude and a current altitude of the vehicle, an adjusted power; based on static power, associated with the location, and the adjusted power, generating a target power generation amount to be supplied to a battery of the vehicle; and controlling, based on the target power generation amount, the vehicle.

Also, or alternatively, a vehicle may comprise a battery of the vehicle; one or more processors; and a memory storing instructions that, when executed, configure the one or more processors to: generate, based on a location of the vehicle, a predicted altitude of the vehicle, set, based on map information indicating the vehicle is driving in a high-energy area, a highest altitude of the high-energy area as a highest predicted altitude, generate, based on the predicted altitude, the highest predicted altitude and a current altitude of the vehicle, an adjusted power, based on static power, associated with the location, and the adjusted power, generate a target power generation amount to be supplied to the battery; and control the vehicle based on the target power generation amount.

These and other features and advantages are described in greater detail below.

### BRIEF DESCRIPTION OF THE DRAWINGS

FIG. 1 shows an example of a vehicle communicating with another device to transmit and receive data.

FIG. 2 shows an example of constituent modules of a vehicle according to an example of the present disclosure.

FIG. 3 is a flowchart of a method for controlling the vehicle by altitude prediction based on high-energy area information according to another example of the present disclosure.

FIG. 4 shows an example of map information.

FIG. 5 shows an example of a driving direction.

FIG. 6 shows an example of existence probabilities according to anomalies representing a current location and an expected driving location based on a driving direction.

FIG. 7 shows an example of an SOC target map.

FIG. 8 shows an example of a target state of charge according to a predicted front altitude.

FIG. 9 shows an example of a correlation table between state-of-charge difference and adjusted power.

FIG. 10 shows an example of modules of a target power generation amount control logic.

FIG. 11 shows an example of data related to determination of fuel cell power generation amount according to a conventional vehicle control method.

FIG. 12 shows an example of data related to determination of fuel cell power generation amount according to the vehicle control method of this example.

### DETAILED DESCRIPTION

Hereinafter, examples of the present disclosure are described in detail with reference to the accompanying drawings so that those having ordinary skill in the art may easily implement the present disclosure. However, other examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

Advantages and features of the present disclosure and the ways of attaining them should become apparent to those of ordinary skill in the art with reference to examples of the present disclosure described herein in detail in conjunction with the accompanying drawings. The present disclosure, however, may be embodied in many different forms and should not be construed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and when drawings illustrated in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

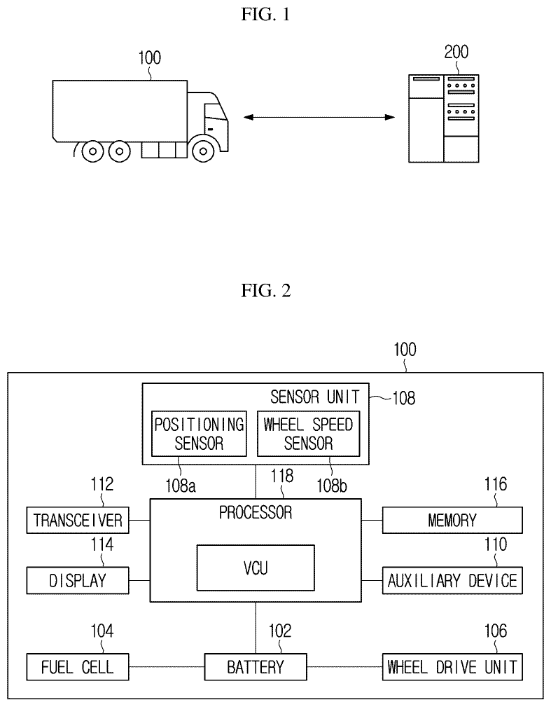

Hereinafter, with reference to FIG. 1 and FIG. 2, a vehicle implementing control by altitude prediction based on high-energy area information according to an example of the present disclosure will be described. FIG. 1 is a view exemplifying a vehicle communicating with another device to transmit and receive data.

Referring to FIG. 1, a vehicle 100 may be driven by an energy source, such as based on electric energy or fossil energy. An electric energy-based vehicle 100 may employ a gas-based fuel cell as an energy source. In the case of a fuel cell, the vehicle 100 may charge a high-voltage battery by power generation of the fuel cell and execute various functions required/used by the modules of the vehicle 100 by output power of the high-voltage battery. In addition, the fuel cell may use various types of gas capable of generating electric energy, and for example, the gas may be hydrogen. However, without being limited thereto, various gases are applicable. The fossil energy-based vehicle 100 may be driven by an internal combustion engine that employs petroleum as an energy source.

The present disclosure describes an example in which an electric energy vehicle is a fuel cell-based vehicle. However, the present disclosure is applicable to a vehicle where a high-voltage battery and a cell are of different types than those disclosed herein, as long as the vehicle employs a method of charging the high-voltage battery by power generation of the cell to output power for the start-up, drive and accessories of the vehicle 100.

The vehicle 100 may refer to a device capable of transporting cargo and/or people. The vehicle 100 may be a passenger vehicle and/or a commercial vehicle, a mobile office, and/or a mobile hotel. The vehicle 100 may be a four-wheel vehicle, for example, a sedan, a sports utility vehicle (SUV), and a pickup truck and may also be a vehicle with five or more wheels, for example, a bus, a lorry, a container truck, and a heavy vehicle. The vehicle 100 may be a manned and/or unmanned vehicle. The vehicle may be a robot. The vehicle may use a plurality of batteries, such as a robot device for construction machinery. The vehicle 100 may be implemented by manual driving and/or autonomous driving (either semi-autonomous or full-autonomous driving).

The vehicle 100 may perform communication with another device or another vehicle under the control of a communication control unit (CTU) mounted in the vehicle 100. For example, another device may include a server 200 for supporting various control, state management and driving of the vehicle 100, an ITS device for receiving information from an intelligent transportation system (ITS), and various types of user devices.

The vehicle 100 may communicate with another vehicle or another device based on cellular communication, wireless access in vehicular environment (WAVE) communication, dedicated short range communication (DSRC) or short range communication, or any other communication scheme.

For example, the vehicle 100 may use a cellular communication network such as long term evolution (LTE) or other 3GPP standards, a communication network such as 5G, a WiFi communication network, a WAVE communication network, and the like to communicate with the server 200 and/or another vehicle. In addition, DSRC used in the vehicle 100 may be used for vehicle-to-vehicle communication. A communication scheme between the vehicle 100 and another device is not limited to the above-described example.

The server 200 may transmit various types of information and/or software modules for controlling the vehicle 100 to the vehicle 100 (e.g., in response to a request and/or data transmitted from the vehicle 100). For example, the server 200 may provide map information, road information, traffic information and/or weather information, which assist in driving, to the vehicle 100. The map information may include, map data expressed in two-dimensional locations and/or elevation map information including altitude data corresponding to the two-dimensional locations. The server 200 may be operated by an organization controlling and managing the driving of the vehicle 100 or a vehicle manufacturer.

In one example, elevation map information may be a numerical elevation map. The numerical elevation map may be made in a map form by measuring altitudes of the ground surface, not man-made artificial works. For the numerical elevation map, a digital elevation map (DEM), which an altitude of a corresponding ground surface point to be identified, may be used, and a ground surface point may be expressed by a latitude and a longitude. For a void region, that is, a region for which there is no observation data such as altitudes, the numerical elevation map may be generated by referring to data related to a void region of another map. Data of the numerical elevation map are marked by h(ϕ, λ) and an altitude (m), and here, ϕ and λ are a latitude and a longitude respectively.

The numerical elevation map may be stored in the vehicle 100 and/or be compressed for transmission, since it may comprise substantial data for transmission between a server (e.g., GPS server) and the vehicle, for example in real time. In another example, elevation map information may not include all the altitudes of the numerical elevation map but may include a high-energy area described below and area information thereof. A high-energy area may be an area that requires/causes a change of driving power control because of a gradient on a road or terrain. The high-energy area may be (e.g., identified and/or defined as) an area where power usage required by a gradient on a road or terrain is estimated to be equal to or greater than a threshold power. Herein, the gradient of the high-energy area may be an uphill gradient with an upward slope given a direction of traffic. The high-energy area may be designated in/by the server 200 that provides map information. The high-energy area may be set (e.g., identified/determined/defined) based on the uphill gradient and further based on a vehicle condition/characteristics (e.g., age, size, tires, etc.) and/or a road condition. For example, the vehicle condition may be a specification of the vehicle 100, a vehicle weight attributable to loaded freight, a vehicle speed, and the like. For example, the road condition may be a road surface condition like a road material, an overall length of an uphill road, and/or a degree of turn. For convenience of explanation, the present disclosure exemplifies transmission of map information including all the altitude data of a numerical elevation map and information on a high-energy area to the vehicle 100. The information on a high-energy area may include a regional range and/or a highest altitude of the high-energy area that is selected from the numerical elevation map and a related terrain. For example, the regional range may be a range set by a latitude and a longitude, and high-energy areas may form a cluster in the regional range and/or be grouped to be managed.

FIG. 2 is a view showing constituent modules of a vehicle according to an example of the present disclosure. The vehicle 100 may include a battery 102, a fuel cell 104 and a wheel drive unit 106.

The battery 102 may be charged by electricity generation of the fuel cell 104. The battery 102 may supply necessary power to a module of the vehicle 100. The battery 102 may be a high-voltage battery and/or may be configured as a secondary cell. For example, the battery 102 may provide energy for the start-up and/or drive of the vehicle 100 and/or an operation of an auxiliary device 110. The battery 102 may provide energy (e.g., from the fuel cell 104) for startup, driving, lighting, air-conditioning and/or various electrical devices of the vehicle 100. The battery 100 may output a higher voltage than the fuel cell 104 and/or supply energy to, for example, the wheel drive unit 106 and/or a high-power electric module.

The fuel cell 104 may include a hydrogen fuel cell that generates electric energy via reaction between hydrogen supplied from a tank (not shown) and oxygen (e.g., coming from air outside. The fuel cell 104 may generate power according to a power generation amount determined based on power requirements of the vehicle 100 (e.g., based on power requirements of start-up and/or travel drive and/or the auxiliary device 110) and charge the battery 102 with the generated power. In some examples, the fuel cell 104 may provide energy to a low-power electric module mounted in the vehicle 100.

A converter, such as a module serving as a step-up/step-down transformer, may convert and/or supply voltage from the fuel cell 104 to the battery 102, thereby charging the battery 102. According to an operating situation, the converter may supply power at a converted voltage to the wheel drive unit 106 and various electronic devices that operate in a high-voltage range. For example, the electronic devices may be/comprise the auxiliary device 110.

The wheel drive unit 106 may be a module that receives power from the battery 102 (and/or fuel cell 104) and drives wheels of the vehicle 100. The wheel drive unit 106 may include a motor unit (e.g., a motor) and a wheel unit (e.g., a wheel). For example, every wheel unit may be driven by being connected with the motor unit. As another example, only some of the wheel units may be coupled with the motor unit, and the wheel units not coupled with the motor unit may be driven by the wheel units driven from a motor. A wheel unit may be equipped with a wheel and a wheel brake module (e.g., a brake). The wheel brake module may be a module that decreases the speed of a wheel by transmitting a braking force to the wheel at a deceleration control request of a driver and/or a processor 118.

The motor unit may generate a driving force by receiving electric power from the battery 102 (e.g., with/based on electric power received from the battery 102). As the motor transmits a driving force to a wheel unit, the wheel unit may be driven to rotate. For example, the motor unit may be equipped with a motor for transmitting a driving force to the wheel unit and a motor control module for controlling motor torque, a motor turning direction, and braking. The motor unit may be driven by electric power applied and supplied from the battery 102 via an inverter (not shown). The inverter may convert a specific form of electric power of the battery 102 (for example, alternating current) to another form (for example, direct current). The inverter may also, or alternatively reduce a voltage. The inverter may also convert a predetermined form of reverse power of the motor unit caused by regenerative braking into a suitable form for the battery 102 and provide the power to the battery 102.

The vehicle 100 may include a sensor unit 108, the auxiliary device 110, a transceiver 112, a display 114, a memory 116 and the processor 118.

The sensor unit 108 may be equipped with various types of sensor modules for sensing various states and situations that occur in internal and external environments of the vehicle 100. For example, the sensor unit 108 may be equipped with a positioning sensor 108a and a wheel speed sensor 108b.

The positioning sensor 118a may measure a location comprising two-dimensional location (e.g., corresponding to longitude/latitude) and/or an altitude of the vehicle 100 (e.g., from sea level) to detect a location of the vehicle 100. The position sensor 118 may measure the two-dimensional location and/or altitude during driving to detect a location of the vehicle 100 during driving. For example, the positioning sensor 108a may be/comprise a global positioning system (GPS) sensor and/or a global navigation satellite system (GNSS) sensor. For example, the GPS sensor may measure a two-dimensional location of the vehicle 100 based on information transmitted from a plurality of satellites. The positioning sensor 108a is not limited to a GPS sensor but may consist of one or more sensors comprising the GPS sensor and/or another sensor and/or a combination thereof. For example, the wheel speed sensor 108 may be configured to be connected to an electric brake system (EBS) and thus measure a vehicle speed.

The sensor unit 108 may include an image sensor, a Lidar sensor, a laser sensor, a distance sensor, an acceleration sensor, and/or the like (e.g., any sensor configured to provide/detect the information for performing the methods described herein, and/or equivalents or substitutions thereof).

The auxiliary device 110 may be an auxiliary equipment mounted on the vehicle 100. The auxiliary device may consume power supplied from the battery 102, for example, based on use of the auxiliary device 110 and/or of the vehicle 100, such as by an occupant and/or a user. The auxiliary device 110 may be a type of electric device for non-driving purpose excluding a driving power system like the wheel drive unit 106 in the present disclosure. For example, the accessories may be an air-conditioning system, a light system, a seat system, and various devices installed in the vehicle 100.

The transceiver 112 may support mutual communication with the server 200, the neighbor vehicle 100, a roadside base station, or a user device.

In the present disclosure, under control of a communication control unit (CTU), the transceiver 112 may transmit data generated or stored during driving to the server 200 and receive data and a software module transmitted from the server 200. In the present disclosure, the vehicle 100 may receive, through the transceiver 112, map information including a numerical elevation map or information on a high-energy area from the outside.

The display 114 may serve as a user interface. By the processor 118, the display 114 may display an operating state and a control state of the vehicle 100, route/traffic information, a battery state, information on a gas remaining quantity, a content requested by a driver, and the like to be output. The display 114 may be configured as a touch screen capable of sensing a driver input and receive a request of a driver indicated to the processor 118. The display 114 may provide a navigation application according to a user request and visually display route information to a destination during driving based on a destination setting of the user. The navigation application may be stored in the memory 116 and be executed by the processor 118 and provide a driving location of the vehicle 100 to the user with reference to location and map information of the positioning sensor 108a.

The memory 116 may store an application for controlling the vehicle 100 and various data and load the application or read and record data at a request of the processor 118. In the present disclosure, the memory 116 may generate a target power generation amount to be supplied to the battery 102 by using altitude prediction based on high-energy area information and store an application and at least one instruction for controlling predicted power of the fuel cell 104 based on the target power generation amount. To this end, for example, the memory 116 may store and manage map information including a numerical elevation map and information on a high-energy area. Information on a high-energy area may include cluster information of each high-energy area and spot information related to high-energy spots belonging to the area. For example, among a plurality of spots belonging to a high-energy area, cluster information may include a highest altitude of a spot with a highest elevation, a lowest altitude of a spot with a lowest elevation and latitude and longitude ranges of the area. Spot information may include gradient data of each spot that belongs to a high-energy area. For example, gradient data may be described as a gradient vector field.

The processor 118 may perform overall control of the vehicle 100. The processor 118 may be configured to execute an application and an instruction stored in the memory 116. In relation to the present disclosure, the processor 108 may execute processing of creating a predicted altitude based on a location and a driving direction of the vehicle 100 by using an application, an instruction and data stored in the memory 116. In response to driving of the vehicle 100 in a high-energy area that is identified in map information, the processor 118 may execute processing of setting a highest altitude of the high-energy area as a highest predicted altitude. The processor 118 may implement processing of generating adjusted power based on a predicted altitude, a highest predicted altitude, and a current altitude of the vehicle. Based on a static power (e.g., base power) and an power that are required/estimated/determined based on a location of the vehicle 100 and are to be supplied to the battery 102, the processor 118 may generate a target power generation amount to be supplied and execute processing of controlling predicted power of the fuel cell 104 based on the target power generation amount.

The above-described processing may be performed in at least a part of the processor 118, for example, in at least one processor module and in at least a part of the memory 130.

As another example, the above-described processing may be performed in a plurality of processing modules and a memory incorporated in each module, and the plurality of processing modules and the embedded memory may constitute the processor 118 and the memory 116 according to the present disclosure.

For example, the plurality of processing modules may consist of individual processing modules for controlling each member of the vehicle 100 and a higher processing module for managing the individual processing modules at a higher level. The higher processing module for managing all the individual processing modules may be a vehicle control unit (VCU) 130. The VCU 122 may generate a predicted altitude and a highest predicted altitude based on data obtained by an individual processing module, a location of the vehicle 100 and a driving direction thereof, calculate adjusted power based on the generated altitudes and process driving power control according to the adjusted power.

In the present disclosure, for convenience of explanation, the processor 118 is described to include individual and higher processing modules and to process the above-described control. Accordingly, in the present disclosure, a processor means a conceptual controller including a single processing module or a plurality of processing modules.

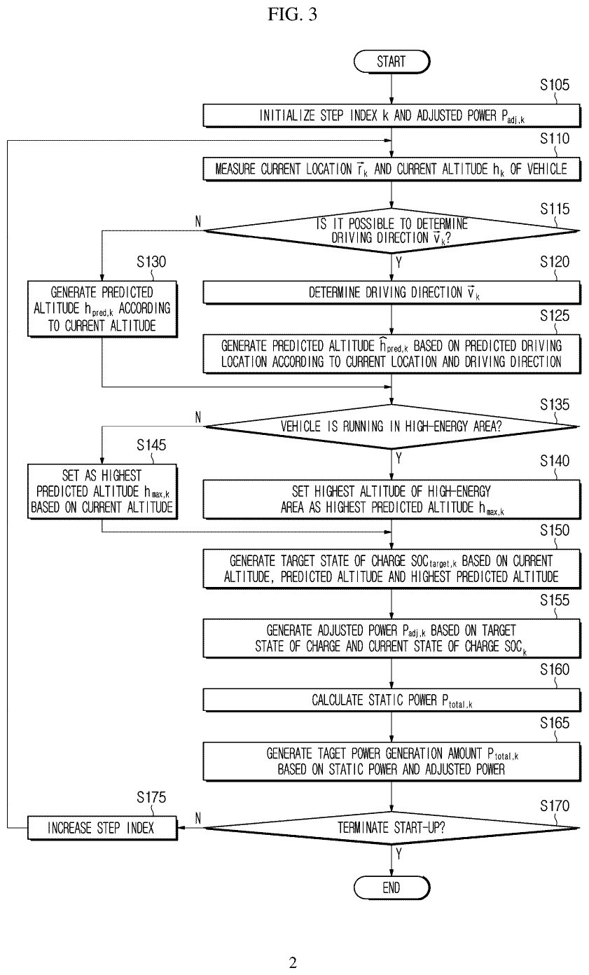

The above-described processing of the processor 118 will be described in detail through FIG. 3 to FIG. 10. Referring to FIG, a method for controlling the vehicle by altitude prediction based on high-energy area information according to another example of the present disclosure will be described in detail. FIG. 3 is a flowchart of a method for controlling the vehicle by altitude prediction based on high-energy area information according to another example of the present disclosure. In the present disclosure, the processor 118 performs the method according to this example, but for convenience of description, the processor 118 and the vehicle 100 may be described interchangeably. This example may assume a case where a user of the vehicle 100 executes no navigation application and a route to a destination is not perceived by the processor 118. Accordingly, in this example, predictive power control may be performed using data that is acquired or measured based on a location of the vehicle 100 according to a user's driving.

First, the processor 118 of the vehicle 100 may initiate a step index k and adjusted power P_{adj.k} in order to start a process for controlling power of the vehicle 100 by generating adjusted power and a target power generation amount during driving (S105).

The process may predict generated power, of the fuel cell 104 and that is supplied to the battery 102, based on data that is obtained or measured in time series. Step indexes may refer to times that are sequentially given to distinguish data obtained at a specific time from that of another time. For example, a step index may be given periodically or at different/variable time intervals or be given every time a specific event of the vehicle 100 occurs. For initialization, the processor 118 may set the step index and the adjusted power to 0.

The processor 118 may measure a current location \vec{r}ₖ, of the vehicle 100 and corresponding to a corresponding step index k, during driving and also obtain a current altitude hₖ (S110).

For example, the processor 118 may measure a current location of the vehicle 100 by using a positioning sensor and/or map information. The current location may be a two-dimensional location of the vehicle 100, such as may be/comprise a latitude and a longitude. Hereinafter, for convenience of description, a two-dimensional location may be referred to as a location.

For example, the processor 118 may obtain an altitude of the vehicle 100 at a current location by using the measured location and map information.

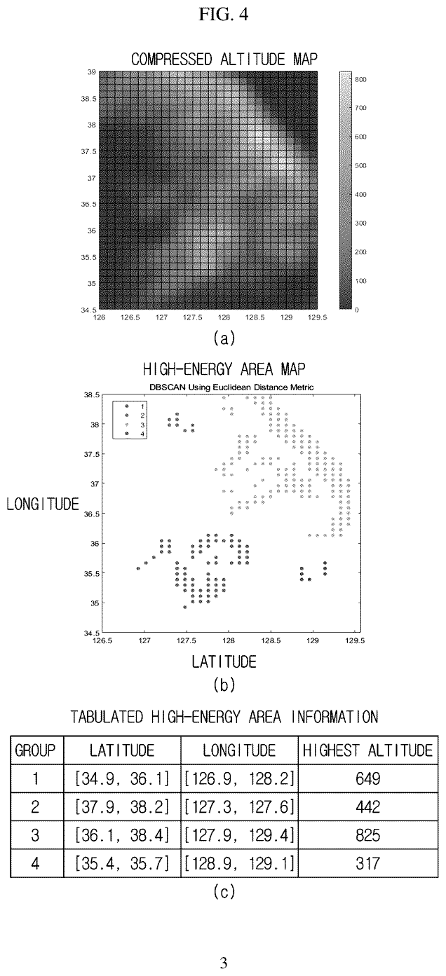

The map information may be embedded in the memory 116 and/or the processor 118 (e.g., VCU) and include, as described above, map data represented in two-dimensional locations, and corresponding altitude data and/or other information related to an energy levels (e.g., indicating and/or corresponding to high-energy areas). The altitude data may be provided as a numerical elevation map corresponding to two-dimensional location data. The map information may include a latitude, a longitude and an altitude for each specific spot. As exemplified in FIG. 4, the numerical elevation map may be a compressed numerical elevation map (which may also be referred to as a compressed altitude map below). FIG. 4 is a view exemplifying map information. A compressed altitude map is described through interconnections of latitudes, longitudes and altitudes and may be a map for an overall specific area in one example or be a map selectively representing high-energy areas in another example.

Also, or alternatively, a compressed altitude map may be a map where a latitude ϕ and a longitude λ, expressed by angles, of a location are transformed into a map matrix index that is composed of p and q. A current altitude may be obtained by using the transformed map. For a detailed description of a compressed altitude map based on a transformed map, latitudes and longitudes ϕ and λ expressed by angles of locations may be transformed into map matrix indexes composed of p and q, and thus the compressed altitude map may be provided. The compressed altitude map may be tabulated or be formed as a grid map so that altitudes corresponding to p and q may be arranged. For example, the transformation may be processed as linear transformation such as

$$p = 1 + \frac{( λ - {λ}_{0} )}{Δ λ} , q = 1 + \frac{( ϕ - {ϕ}_{0} )}{Δ ϕ} ,$$

and a latitude and a longitude that are expressed by angles may be transformed into values of p and q through the linear transformation. In the case of Korea, for λ₀, ϕ₀, Δλ and Δϕ, which are parameters used for the linear transformation, λ₀=126°, ϕ₀=34°, Δλ=λϕ=0.125°=13.915 km may be applied. As Earth is not a sphere but a spheroid, it is possible to consider that transformation from angles to a distance unit (e.g., km) is differently applied to the latitude and the longitude. However, since the difference is slight, if it is assumed in the present disclosure that Earth is a sphere with a radius of 6,378 km, when a current location, that is, (latitude, longitude) or an index (p, q) is obtained, the processor 118 may calculate a current altitude hₖ by applying bilinear interpolation to a compressed altitude map.

As exemplified in FIG. 4, map information may include high-energy area-related information including a high-energy area map and high-energy area information. A high-energy area map may be provided to express a regional range of a high-energy area selected from a terrain associated with a numerical elevation map. High-energy areas may cluster in a regional range, and high-energy areas may be grouped to be managed. For example, a high-energy area may be an area where power usage required by (e.g., used for driving on) a gradient on a road or terrain is estimated to be equal to or greater than a threshold power. In the example of estimation of the area, a spot belonging to the high-energy area may be extracted/estimated/determined/identified based on altitude data of map information and/or a reference altitude change amount. The reference altitude change amount may be defined as an altitude change amount that requires a change in a plan of driving power control that is applied to current driving of the vehicle 100 (e.g., at a given location). High-energy area information may include a regional range and/or a highest altitude of a high-energy area that is selected from a numerical elevation map and a related terrain. As exemplified in FIG. 4, high-energy area information may be provided by tabulating cluster information of each high-energy area that consists of displacements of latitudes and longitudes corresponding to the boundary of the high-energy area and/or a highest altitude and/or a lowest altitude (not illustrated).

The processor 118 may determine whether or not a driving direction \vec{v}ₖ can be determined based on vehicle data and sensing performance in a current location (S115).

For example, the vehicle data and the sensing performance may be position sensing consistency of the positioning sensor 108a constituting the sensor unit 108, a vehicle speed, and/or location data between the past and the present. If there is at least one of degraded consistency of the positioning sensor 108a (and/or inconsistency of the positioning sensor), for example based on the number of provisionally observed satellites, a vehicle speed equal to or lower than a reference vehicle speed and/or location inconsistency between the past and the present, the processor 118 may determine that a driving direction cannot be determined. A condition related to at least one of the situations may be referred to as an “impossible condition of driving” (S115—N).

If none of the above-listed conditions is present, and/or if sufficient reliable sensing performance and/or position sensing consistency are detected, the processor 118 may determine that a driving direction can be determined (S115—Y).

If a condition for determining a driving direction is satisfied, the processor 118 may perform a process of determining the driving direction. The processor 118 may determine a driving direction \vec{v}ₖ based on a location history that is tracked from driving so far (S120).

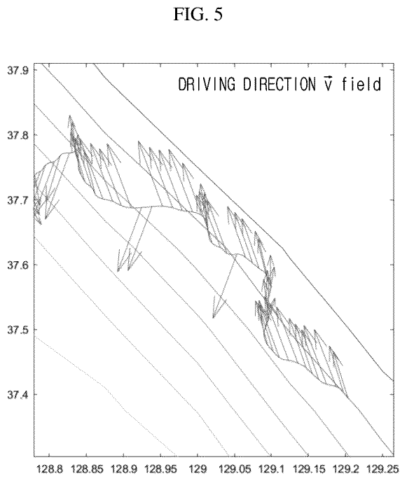

For example, as exemplified in FIG. 5, the driving direction may be obtained by backward finite differencing that uses past locations from a predetermined time ago to the present. FIG. 5 is a view exemplifying a driving direction. In order to apply the finite differencing technique, a function based on location history may be constructed from a basic first-order first-order function to a first-order higher-order function. As the order increases, the past location information may be more required.

The processor 118 may generate a predicted altitude ĥ_{pred,k} based on a location of the vehicle 100 and an expected driving location according to a driving direction (S125).

As for a detailed description of generation of the predicted altitude, the processor 118 may generate expected location data based on a location, a driving direction and a predetermined expected driving distance from the vehicle 100 so that front locations of the vehicle 100 are probabilistically distributed. Herein, the front locations, which are probabilistically distributed, may be distributed according to anomalies that are separated at a predetermined spacing in a driving direction within an expected driving distance. Then, the processor 118 may generate predicted altitudes based on expected front altitudes that are generated according to the distributed front locations.

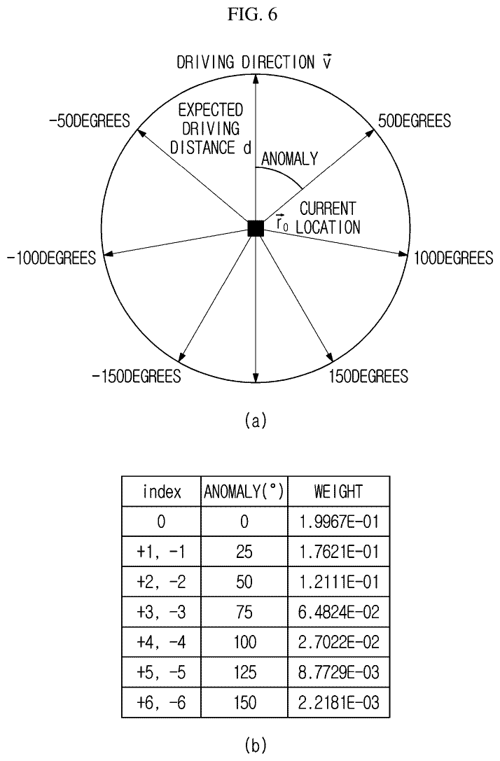

For a further detailed description of the above-described process, based on a current location \vec{r}₀, a driving direction \vec{v} and an expected driving distance (and/or a predicted radius) d, a front location after the vehicle 100's running a front distance d may be predicted based on a truncated Gaussian probability distribution. The expected driving distance may be set according to a design specification (e.g., a design type of a vehicle or related product). For example, when a truncated Gaussian probability distribution restricted to a standard deviation σ=50° and a range of [−3σ, 3σ] is used, probabilities of a front location (or a future location probability) according to the anomalies in part (a) of FIG. 6 may be expressed by weights, such as shown in the table exemplified in part (b) of FIG. 6. FIG. 6 shows a view exemplifying existence probabilities according to anomalies representing a current location and an expected driving location based on a driving direction. That is, the front locations, which are probabilistically distributed, may be distributed according to anomalies that are separated at a predetermined spacing in a driving direction \vec{v} within an expected driving distance d. When

$${\vec{r}}_{0} + {( R ( 2 {5}^{∘} ) )}^{i} \vec{\frac{v}{v}} d$$

represents a front location, a probability in which the vehicle 100 is in the location may be w_{|i|}. Here, i may represent an anomaly index. Based on what is described, a distribution of front locations, which are evaluated by probabilities, may be referred to expected location data.

If a location is identified via a compressed altitude map, an altitude may be determined. Accordingly, if expected location data and/or presence probabilities of anomaly locations are used, a predicted altitude ĥ_{pred} may be obtained by Equation 1.

$${\hat{h}}_{p r e d} = {\sum }_{i = - 6}^{6} {w}_{\vert i \vert} H ( {\vec{r}}_{0} + {( R ( 2 {5}^{∘} ) )}^{i} \vec{\frac{v}{v}} d ) \qquad [ Equation 1 ]$$

Here, H(\vec{r}) may be an altitude approximation function of a corresponding location, and R may be a rotational matrix.

If, at step S115, there is a condition for impossibility to determine a driving direction (S115—N), the processor 118 may generate a predicted altitude based on a current altitude hₖ in a current location of the vehicle 100 (S130) (e.g., use the current location of the vehicle 100 to determine the current altitude hₖ). In an example, the current altitude hₖ is used as a predicted altitude h_{pred,k}. In an example, if a driving direction cannot be determined, the current altitude may be used as a predicted altitude.

By using the current location and map information, the processor 118 may determine whether or not the vehicle 100 is running in a high-energy area that is identified in the map information (S135).

If the vehicle 100 is located in the high-energy area (Y of S135), the processor 118 may set a highest altitude of the high-energy area, to which the current location belongs, as a highest predicted altitude h_{max.k} (S140). On the other hand, if the vehicle 100 is running in an area that is not a high-energy area (N of S135), the vehicle 100 may set the highest predicted altitude based on a current altitude hₖ of the vehicle 100 in the current location (S145).

In relation to steps S140 and S145, as high-energy area information is present in a specific area, a highest predicted altitude of a terrain may be defined as shown in Equation 2.

$${h}_{m ax} = \{ \begin{matrix}{max}_{i} ( {h}_{i , m ax} ) , & i s . t . \vec{r} ∈ {S}_{i} \\ h , & ∄ i s . t . \vec{r} ∈ {S}_{i}\end{matrix} \qquad [ Equation 2 ]$$

Here, Sᵢ may be a set of all location vectors that belong to an i-th high-energy area (or high-energy terrain). If a location of a vehicle at a specific time belongs to one or more high-energy terrains, Equation 2 indicates that a highest predicted altitude is set to a highest value of altitudes h_{i,max} predicted in the terrains. If a vehicle is not located in a high-energy terrain, a current altitude may be set as a highest predicted altitude of a terrain.

The processor 118 may generate a target state of charge SOC_{target,k} based on a current altitude, a predicted altitude and a highest predicted altitude (S150).

The current altitude may be an altitude obtained at step S110, the predicted altitude may be an altitude generated at step S125 or step S130, and the highest predicted altitude may be an altitude obtained at step S140 or step S145.

The target state of charge may be a state of charge (SOC) that is required for the battery 102. For example, it may be a target SOC that is determined according to a correlation of the altitudes. The target state of charge may be obtained based on a function of T₁(h_{max,k}−hₖ, ĥ_{pred,k}−hₖ).

The function may mean that the target SOC of the battery 102 is obtained based on (e.g., as a function of) a difference between a predicted altitude and a current altitude and a difference between a highest predicted altitude and the current altitude.

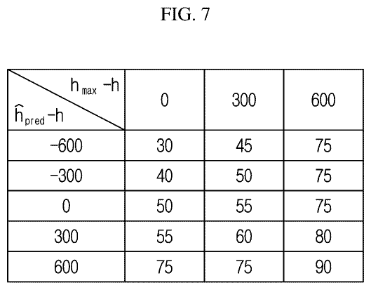

As exemplified in FIG. 7, such a function may be constructed as a tabulated SOC target map, and the processor 118 may search for a target SOC corresponding to the differences in the SOC target map. FIG. 7 is a view exemplifying an SOC target map, with target SOC entries in terms of percent. The values of the exemplified SOC target map may be modified according to a maximum weight of the vehicle 100, an output limit of a fuel cell system, and a highest altitude of a specific region. As shown in FIG. 7, if the difference between a predicted altitude and a current altitude and the difference between a highest predicted altitude and the current altitude are −600 and 0 respectively, a target SOC is set to be 30%. As this corresponds to a situation where a vehicle is located on the top of a high-energy terrain, the target SOC is set to remain in a low SOC. If the difference between a predicted altitude and a current altitude and the difference between a highest predicted altitude and the current altitude are −600 and 600 respectively, this is estimated to be a situation where a vehicle is located at a middle altitude of a high-energy terrain, and thus a target SOC is set to stay as an optimal SOC. That is, if the difference between a predicted altitude and a current altitude and the difference between a highest predicted altitude and the current altitude are 600 and 600 respectively, as this is estimated to be a situation where a vehicle is located in a low land of a high-energy terrain, and thus a target SOC is set to be/stay as a highest SOC.

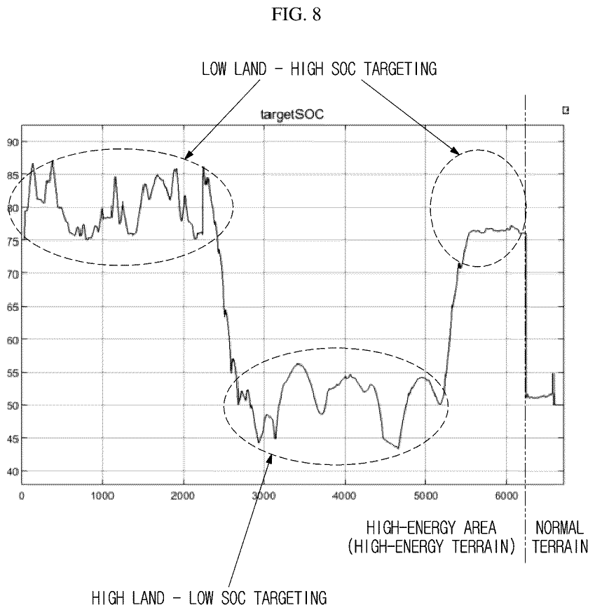

A simulation result of a target SOC, which is set by reflecting the above-described situations, is exemplified in FIG. 8. FIG. 8 is a view exemplifying a target state of charge according to a predicted front altitude. If power prediction control is applied, a high SOC is targeted in a low land of a high-energy terrain and/or a low SOC is targeted in a high land of the high-energy terrain, such that the SOC of the battery 102 may be preemptively secured in preparation for (e.g., predicted) uphill and/or downhill driving.

The processor 118 may generate adjusted power P_{adj.k} based on a target state of charge SOC_{target,k} and a current state of charge SOCK of the battery 102 (S155).

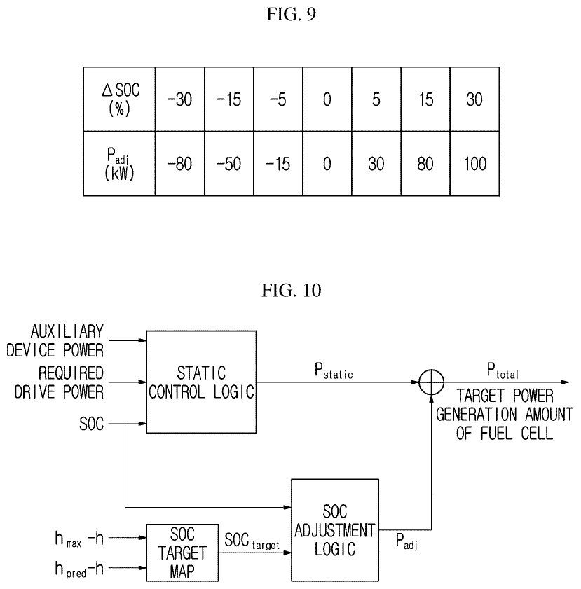

The adjusted power may be obtained based on a difference between the target SOC and the current SOC. For example, as shown in FIG. 9, the adjusted power may be obtained from a correlation table related to a difference between the states of charge. FIG. 9 is a view exemplifying a correlation table between state-of-charge difference and adjusted power.

If altitude prediction control to be provided to the battery 102 is not considered, the processor 118 may calculate static power P_{static,k} required for the vehicle based on a current state of charge and an accelerator pedal stepping amount (S160).

FIG. 10 is a view showing a target power generation amount control logic. Static power may include drive power required for driving of the vehicle 100 in a current location and/or a second power, such as an accessories power expected in the auxiliary device 110. For example, the required drive power may be power required for the wheel drive unit 106, and/or the accessories power may include expected future power usage based on current usage, such as may be attributable to a user's current use of an air-conditioning system, as an example. The accessories power is not limited to the above-described example, but may include power that is expected due to the use of another module of the auxiliary device 110.

The processor 118 may generate a target power generation amount P_{total,k} to be supplied to the battery 102 based on static power and adjusted power and control power of the vehicle 100 based on the target power generation amount (S165).

As shown in FIG. 10, the processor 118 may calculate the target power generation amount by adding up the static power and the adjusted power. The target power generation amount may be a target power generation amount of the fuel cell 104 that is required as power for charging the battery 102. Based on the target power generation amount, the processor 118 may execute charge control of the battery 102 so that the power of the fuel cell 104 is output to make the battery 102 reach a target SOC.

If the start-up of the vehicle 100 does not terminate (N of S170), the processor 118 may increase a step index k, repeat the steps S110 to S165 and thus process power control of the vehicle 100 according to a front altitude.

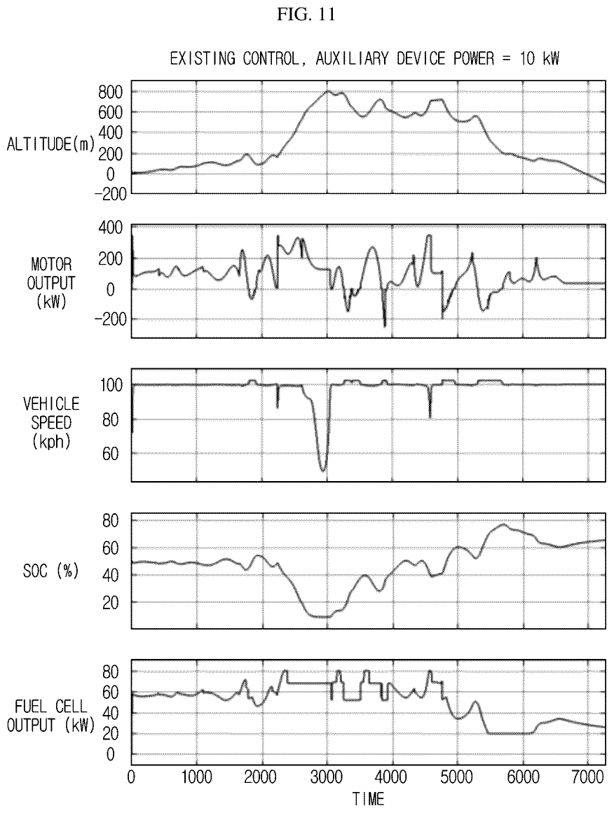

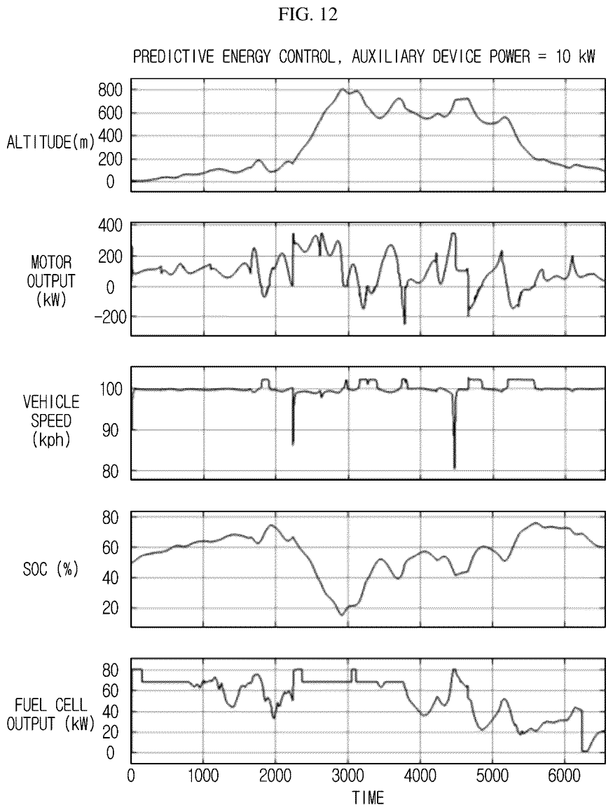

Hereinafter, simulation results according to vehicle control methods according to a conventional example and this example will be described with reference to FIG. 11 and FIG. 12.

FIG. 11 is a view showing data related to determination of fuel cell power generation amount according to a conventional vehicle control method. FIG. 12 is a view showing data related to determination of fuel cell power generation amount according to the vehicle control method of this example.

In FIG. 11 and FIG. 12, the vehicle is a bus with a weight of 17 tones and a hydrogen fuel cell and a battery embedded therein, and simulation conditions according to the methods of FIG. 11 and FIG. 12, that is, altitude, motor output, and vehicle speed are set identically. Static power P_{static,k} is identically set in the two simulations, a SOC at a constant speed of 100 kph is set to be balanced at about 50%, and a SOC for city driving is set to be balanced at 67%. Accessories power is designated to be a level of around 10 kW. The existing method according to FIG. 11 causes a phenomenon of vehicle speed decrease because of a SOC decrease up to SOC 10% during uphill driving under the above condition. On the other hand, the method of this example according to FIG. 12 shows a significantly smaller decrease of vehicle speed during uphill driving under the same condition as that of FIG. 11 because of a SOC decrease of about SOC 20% that is higher than that of the existing method.

The present disclosure provides a vehicle control method by altitude prediction based on identification of a high-energy area and a vehicle using the method in order to implement driving power control through control of predictive power generation for a battery through preemptive identification of the high-energy area on a route.

The technical problems solved by the present disclosure are not limited to the above technical problems and other technical problems which are not described herein will be clearly understood by a person having ordinary skill in the technical field, to which the present disclosure belongs, from the following description.

A method may be performed by an apparatus, of a vehicle, for controlling a vehicle by using altitude prediction based on high-energy area information. The method may comprise: generating a predicted altitude based on a location and a driving direction of the vehicle; in response to driving of the vehicle in a high-energy area identified in map information, setting a highest altitude of the high-energy area as a highest predicted altitude; generating adjusted power based on the predicted altitude, the highest predicted altitude and a current altitude of the vehicle; and based on static power required based on the location and the adjusted power that are to be supplied to a battery of the vehicle, generating a target power generation amount to be supplied to the battery and controlling the vehicle based on the target power generation amount.

The generating of the predicted altitude may comprise: generating expected location data to probabilistically distribute a front location of the vehicle based on the location, the driving direction and a predetermined expected driving distance from the vehicle; and generating the predicted altitude based on an expected front altitude that is generated for the distributed front location.

The front location, which is probabilistically distributed, may be distributed according to anomalies that are separated at a predetermined spacing in the driving direction within the expected driving distance.

The driving direction may be determined based on a location history that is tracked from driving so far.

The generating of the predicted altitude may be performed in response to determination of the driving direction and further comprises providing the predicted altitude based on an altitude of the vehicle in the location in response to non-determination of the driving direction.

The non-determination of the driving direction may occur because of at least one of positioning sensing inconsistency of a sensor unit mounted in the vehicle, a vehicle speed equal to or lower than a reference vehicle speed, and inconsistency between a past location and a current location.

The setting of the highest predicted altitude may further comprise setting the highest predicted altitude based on an altitude of the vehicle in the location in response to non-driving of the vehicle in the high-energy area.

The high-energy area may be an area in which usage power of the battery required by a gradient of a road or a terrain is estimated to be equal or greater than threshold power, and wherein the map information at least includes the highest altitude of the high-energy area that is selected from the terrain.

The static power may include required drive power for driving drive of the vehicle and accessories power expected in an auxiliary device mounted in the vehicle.

The generating of the adjusted power may comprise: generating a target state of charge (SOC) of the battery based on a difference between the predicted altitude and the current altitude of the vehicle and a difference between the highest predicted altitude and the current altitude of the vehicle; and generating the adjusted power based on the target SOC and a current SOC of the battery.

A vehicle may comprise; a sensor unit configured to detect a state of the vehicle and an external environment; a memory configured to store at least instruction for controlling the vehicle; and a processor configured to execute the at least one instruction stored in the memory based on data obtained from the sensor unit and the memory, wherein the processor is further configured to: generate a predicted altitude based on a location and a driving direction of the vehicle, in response to driving of the vehicle in a high-energy area identified in map information, set a highest altitude of the high-energy area as a highest predicted altitude, generate adjusted power based on the predicted altitude, the highest predicted altitude and a current altitude of the vehicle, and based on static power required based on the location and the adjusted power that are to be supplied to a battery of the vehicle, generate a target power generation amount to be supplied to the battery and control the vehicle based on the target power generation amount.

The vehicle may be configured to perform one or more operations and/or methods described herein

The features of the present disclosure, which are briefly summarized herein, are only examples of aspects of features of the present disclosure and detailed description of the disclosure which follows and are not intended to limit the scope of the present disclosure.

The technical problems solved by the present disclosure are not limited to the above mentioned technical problems. Other technical problems solved by the present disclosure, which are not described herein should be more clearly understood by a person having ordinary skill in the art of technical field to which the present disclosure belongs, from the following description.

According to the present disclosure, in order to implement driving power control through control of predictive power generation for a battery through preemptive identification of a high-energy area on a route, it is possible to provide a vehicle control method by altitude prediction based on identification of the high-energy area and a vehicle using the method.

According to the present disclosure, as a maximum output of a fuel cell is limited in an electric energy-based vehicle using the fuel cell, if the electric energy is preemptively stored in a battery before uphill driving, the state-of-charge of the battery may be maintained at a high level, and predictive power generation control of the fuel cell of the vehicle may be realized.

The technical effects to be achieved by the present disclosure are not limited to the above technical effects, and other technical effects not stated herein should be more clearly understood by a person having ordinary skill in the technical field, to which the present disclosure belongs, from the following description.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by a vehicle, the method comprising:
generating, based on a location of the vehicle, a predicted altitude of the vehicle;
setting, based on map information indicating the vehicle is driving in a high-energy area, a highest altitude of the high-energy area as a highest predicted altitude;
generating, based on the predicted altitude, the highest predicted altitude and a current altitude of the vehicle, an adjusted power;
based on static power, associated with the location, and the adjusted power, generating a target power generation amount to be supplied to a battery of the vehicle; and
controlling, based on the target power generation amount, the vehicle.

2. The method of claim 1, wherein the generating of the predicted altitude comprises:
generating expected location data to probabilistically distribute a front location of the vehicle based on:
the location,
a driving direction, and
an expected driving distance from the vehicle; and
generating, based on an expected front altitude according to the front location distribution, the predicted altitude.

3. The method of claim 2, wherein the front location is probabilistically distributed according to anomalies that are separated at a predetermined spacing in the driving direction within the expected driving distance.

4. The method of claim 1, further comprising determining a driving direction, of the vehicle, based on a location history associated with driving of the vehicle, wherein the generating the predicted altitude is further based on the driving direction.

5. The method of claim 1, wherein the generating of the predicted altitude comprises:
based on a failure to determine the driving direction, determine the predicted altitude based on an altitude of the vehicle in the location.

6. The method of claim 5, wherein the failure to determine the driving direction is based on at least one of:
positioning sensing inconsistency of a sensor of the vehicle,
a vehicle speed equal to or lower than a reference vehicle speed, or
inconsistency between a past location and a current location.

7. The method of claim 1, further comprising setting, based on map information indicating the vehicle is not driving in a high-energy area, a second highest predicted altitude.

8. The method of claim 1, wherein the high-energy area comprises an area in which usage power of the battery required by a gradient of a road or a terrain is estimated to be equal to or greater than a threshold power, and
wherein the map information comprises an indication of the highest altitude of the high-energy area.

9. The method of claim 1, wherein the static power comprises a drive power for driving the vehicle and second power associated with an auxiliary device of the vehicle.

10. The method of claim 1, further comprising:
generating, based on a difference between the predicted altitude and the current altitude of the vehicle and a difference between the highest predicted altitude and the current altitude of the vehicle, a target state of charge (SOC) of the battery,
wherein the generating the adjusted power is based on the target SOC and a current SOC of the battery.

11. A vehicle comprising:
a battery of the vehicle;
one or more processors; and
a memory storing instructions that, when executed, configure the one or more processors to:
generate, based on a location of the vehicle, a predicted altitude of the vehicle, set, based on map information indicating the vehicle is driving in a high-energy area, a highest altitude of the high-energy area as a highest predicted altitude,
generate, based on the predicted altitude, the highest predicted altitude and a current altitude of the vehicle, an adjusted power,
based on static power, associated with the location, and the adjusted power, generate a target power generation amount to be supplied to the battery; and
control the vehicle based on the target power generation amount.

12. The vehicle of claim 11, wherein the instructions, when executed by the one or more processors, configure the one or more processors to generate the predicted altitude by:
generating, based on the location, expected location data to probabilistically distribute a front location of the vehicle based on:
the location,
a driving direction of the vehicle, and
an expected driving distance from the vehicle; and
generating, based on an expected front altitude according to the front location distribution, the predicted altitude.

13. The vehicle of claim 12, wherein the instructions, when executed by the one or more processors, configure the one or more processors to probabilistically distribute the front location according to anomalies that are separated at a predetermined spacing in the driving direction within the expected driving distance.

14. The vehicle of claim 11, wherein the instructions, when executed by the one or more processors, configure the one or more processors to:
determine a driving direction of the vehicle based on a location history associated with driving of the vehicle; and
generate the predicted altitude further based on the driving direction.

15. The vehicle of claim 11, wherein the instructions, when executed by the one or more processors, configure the one or more processors to, based on a failure to determine the driving direction, determine the predicted altitude based on an altitude of the vehicle in the location.

16. The vehicle of claim 15, wherein the failure to determine the driving direction is based on at least one of:
positioning sensing inconsistency of one or more sensors of the vehicle,
a vehicle speed equal to or lower than a reference vehicle speed, or
inconsistency between a past location and a current location.

17. The vehicle of claim 11, wherein the instructions, when executed by the one or more processors, further configure the one or more processors to set, based on map information indicating the vehicle is not driving in a high-energy area, a second highest predicted altitude.

18. The vehicle of claim 11, wherein the high-energy area comprises an area in which usage power of the battery required by a gradient of a road or a terrain is estimated to be equal to or greater than a threshold power, and
wherein the map information comprises an indication of the highest altitude of the high-energy area.

19. The vehicle of claim 11, wherein the static power comprises a drive power for driving the vehicle and second power associated with an auxiliary device of the vehicle.

20. The vehicle of claim 11, wherein the instructions, when executed by the one or more processors, configure the one or more processors to generate the adjusted power by:
generating, based on a difference between the predicted altitude and the current altitude of the vehicle and a difference between the highest predicted altitude and the current altitude of the vehicle, a target state of charge (SOC) of the battery; and
generate the adjusted power further based on the target SOC and a current SOC of the battery.
